(19) United States
(12) Patent Application Publication
(10) Pub. No.: US 2014/0125588 A1
(43) Pub. Date: May 8, 2014

(54) ELECTRONIC DEVICE AND OPERATION METHOD THEREOF

(71) Applicant: WISTRON CORP., New Taipei City (TW)

(72) Inventors: Shou-Te Wei, New Taipei City (TW); Shang-Chin Su, New Taipei City (TW); Hsun-Hao Chang, New Taipei City (TW)

(73) Assignee: WISTRON CORP., New Taipei City (TW)

(21) Appl. No.: 13/957,303

(22) Filed: Aug. 1, 2013

(30) Foreign Application Priority Data
Nov. 2, 2012 (TW) 101140704

(51) Int. Cl. G06F 3/041

(52) U.S. Cl. CPC G06F 3/041
USPC 345/157; 345/173

(57) ABSTRACT

A touch system includes a touch screen, an image-sensing device, and a processing device. The image-sensing device generates images related to objects on the touch screen at several points in time. The processing device calculates the average coordinates of the objects based on the images, and calculates the longest distance between the objects. The processing device further determines the coordinates of a drawing spot according to the average coordinates of the objects, and determines a graphical property of the drawing spot according to the longest distance. The processing device further directs the touch screen to display the drawing spot on the coordinates and with the graphical property.

### CROSS REFERENCE TO RELATED APPLICATIONS

This application claims priority of Taiwan Patent Application Ser. No. 101140704, filed 2012 Nov. 2, entitled TOUCH SYSTEM AND METHOD OF MAKING A DRAWING THEREON. The contents of this application are hereby incorporated by reference.

### BACKGROUND OF THE INVENTION

1. Field of the Invention

The disclosure relates generally to computer drawing and, more particularly, to a touch system that has the functions of a drawing operation, and an operation method thereof.

2. Description of the Related Art

Touch screens are becoming more popular for use both as displays and as user input devices, especially for portable devices. New operation interfaces of operation systems and programs are adapted for touch screens in order to provide an intuitive and user-friendly interface. For example, graphics painting programs implemented in a system equipped with a touch screen enable a user to draw a line segment on the touch screen by using his finger.

According to a conventional method for drawing on touch screens, it is convenient to draw a line segment on the touch screen, but when a particular function is to be selected, a hierarchical menu is inconvenient to use.

For example, the Microsoft Paint program in Windows 7™ is now touch-ready, so if a user has a touch screen PC, painting can be executed via the user's finger being placed on the screen. When starting Paint, an empty window will be displayed; and drawing and painting tools are located in the ribbon at the top of the window. These drawing and painting tools are arranged hierarchically. For example, if a user wants to draw a straight line segment, he clicks the Home tab, enters the Shapes group, clicks the Line segment tool, enters the Colors group, clicks Color 1, clicks the color he wants to use, and then drags the pointer or finger across the drawing area. In addition to the complicated selection operations, these tools displayed on the screen are too small to manipulate.

Accordingly, there is a need for more user-friendly procedures for graphical drawing, and methods and devices for implementing the procedures.

### BRIEF SUMMARY OF THE INVENTION

A method of controlling an electronic device with a touch-sensitive screen and an electronic device are provided.

An embodiment of an electronic device includes a touch-sensitive screen, an image-sensing device, and a processing device. The image-sensing device, upon touch detecting a plurality of objects on the touch-sensitive screen, captures image data of the objects. The processing device calculates the average position of the objects according to the image data, and calculates the longest distance between any two of the objects according to the image data. The processing device determines a position for a painting spot according to the calculated average position, determines a property of the painting spot according to the longest distance, and controls the touch-sensitive screen to display the painting spot with the property on the position.

According to an embodiment, the property is the diameter or color of the painting spot.

According to an embodiment, when the plurality of objects is moving on the touch-sensitive screen, the image-sensing device captures the image data of the objects at a plurality of points in time. The processing device calculates the average position for each of the points in time according to the image data, and it calculates the longest distance between any two of the objects for each of the points in time according to the image data. The processing device determines the position of the painting spot for each of the points in time according to the calculated average position for each of the points in time, determines a line segment defined by the painting spots corresponding to the points in time, and determines the color or diameter of each of the painting spots according to the longest distance.

In an embodiment of a method for controlling an electronic device with a touch-sensitive screen, upon touch detecting a plurality of objects on a touch-sensitive screen, image data of the objects is captured. The average position of the objects is calculated according to the image data, and the longest distance between any two of the objects is calculated according to the image data. A position for a painting spot is determined according to the calculated average position, a property of the painting spot is determined according to the longest distance, and the touch-sensitive screen is controlled to display the painting spot with the property on the position.

A method of controlling an electronic device with a touch-sensitive screen and related operating systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of an electronic device of the invention;

FIG. 2 is a flowchart of an embodiment of a method of controlling an electronic device with a touch-sensitive screen;

FIG. 3A illustrates a brightness baseline segment and threshold for a pixel line segment of a standard image according to embodiments of the invention;

FIG. 3B illustrates brightness for a pixel line segment in an object image according to embodiments of the invention;

FIG. 3C illustrates brightness for a pixel line segment in an object image when a user is drawing on a touch-sensitive screen using two fingers;

FIG. 4A illustrates a schematic diagram of a line segment generated from the drawing operation of a single finger according to embodiments of the invention; and

FIG. 4B illustrates a schematic diagram of a line segment generated from the drawing operation of two fingers according to embodiments of the invention.

### DETAILED DESCRIPTION OF THE INVENTION

A method of controlling an electronic device with a touch-sensitive screen and an electronic device are provided.

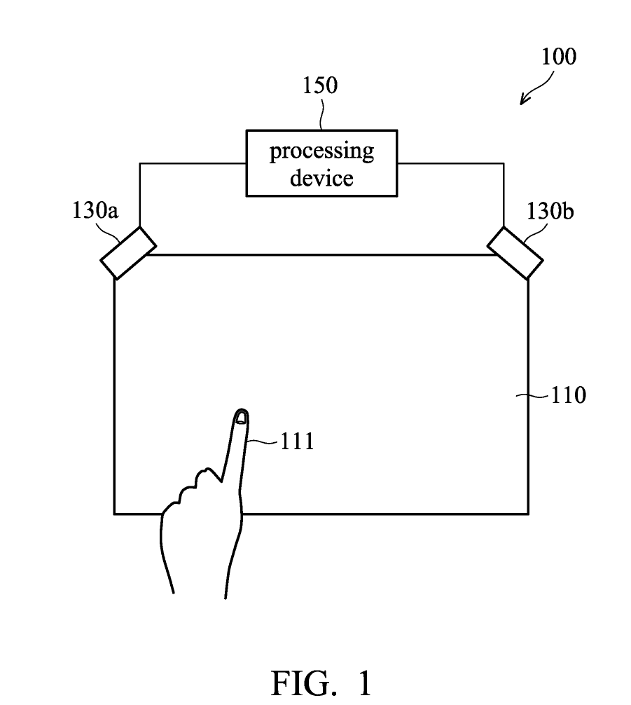

FIG. 1 is a schematic diagram illustrating an embodiment of an electronic device of the invention. According to the embodiment, an electronic device 100 comprises a touch-sensitive screen 110, an image-sensing device 130, and a processing device 150.

The touch-sensitive screen 110 has a touch-sensitive surface. The touch-sensitive screen 110 can detect the contact and movement of an input tool, such as a stylus or finger, on the touch-sensitive surface. The touch-sensitive screen 110 can display related graphics, data, and interfaces. The touch-sensitive screen 110 receives input corresponding to user manipulation, and transmits the received input to the processing device 150 for further processing.

The image-sensing device 130 (including image-sensing device 130a and 130b) captures image windows of the touch-sensitive screen 110 in order to detect the object 111, which is approaching or touching the touch-sensitive screen 110. Referring to FIG. 1, image-sensing devices 130a and 130b are disposed at the corner of the touch-sensitive screen 110. However, it will be appreciated, in light of the following disclosure, that the number and position of the image-sensing device 130 is not limited. The image-sensing device 130 can be implemented by CMOS 2D image sensor or other similar devices. The image-sensing device 130 periodically captures image data according to a preset period. In this disclosure, a standard image refers to image data captured by the image-sensing device 130 when no object is touching the touch-sensitive screen 110. The standard image is used as a standard of reference for determining whether there is an object on the touch-sensitive screen 110.

The processing device 150 executes a method of controlling an electronic device with the touch-sensitive screen of the invention. The processing device 150 operates according to image data captured by the image-sensing device 130. For example, the processing device 150 determines whether there is an object on the touch-sensitive screen 110, calculates the coordinates of the object's position, and determines the motion status of the object. Related details are discussed later.

The object 111 can be a finger, a stylus or another object that can touch and manipulate the touch-sensitive screen 110.

The electronic device 100 can be a personal computer or portable electronic device, such as a PDA (Personal Digital Assistant), a mobile phone, a smartphone, or a mobile Internet Device (MID).

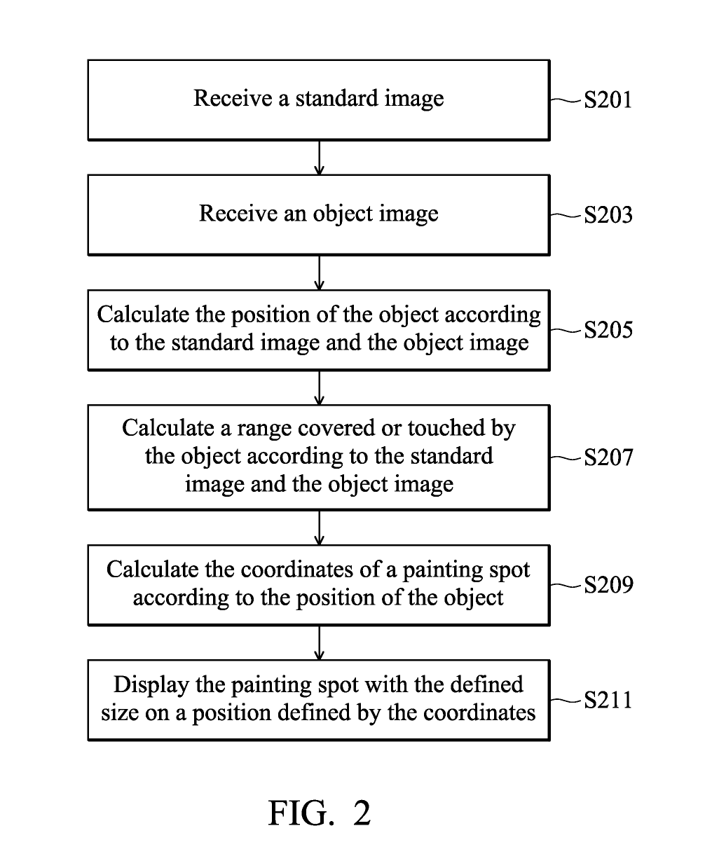

FIG. 2 is a flowchart of an embodiment of a method of controlling an electronic device with a touch-sensitive screen. The method of controlling the electronic device with a touch-sensitive screen can be used in an electronic device, including, but not limited to, a PDA (Personal Digital Assistant), a smartphone, a mobile phone, or the like. According to an embodiment, the electronic device is equipped with a touch-sensitive screen.

While the process flow described below includes a number of operations that appear to occur in a specific order, it should be apparent that these processes may include more or fewer operations, which may be executed serially or in parallel (for example, using parallel processors or a multi-threading environment).

In step S201, a standard image is received. As described, the standard image refers to an image captured when no object is touching the touch-sensitive screen.

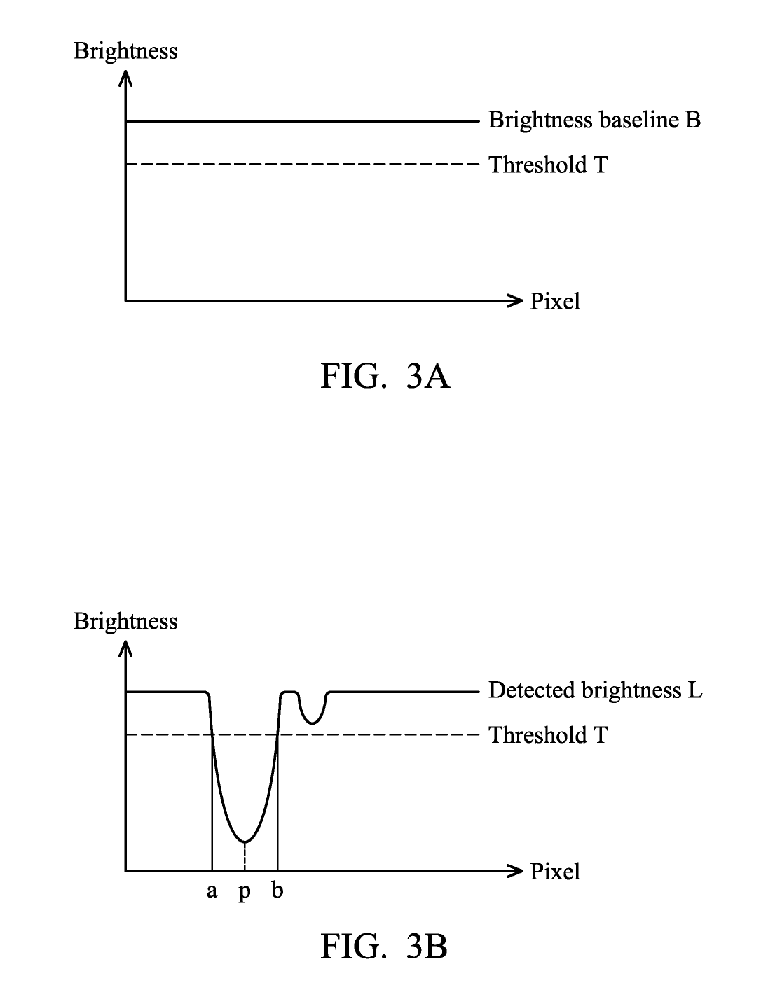

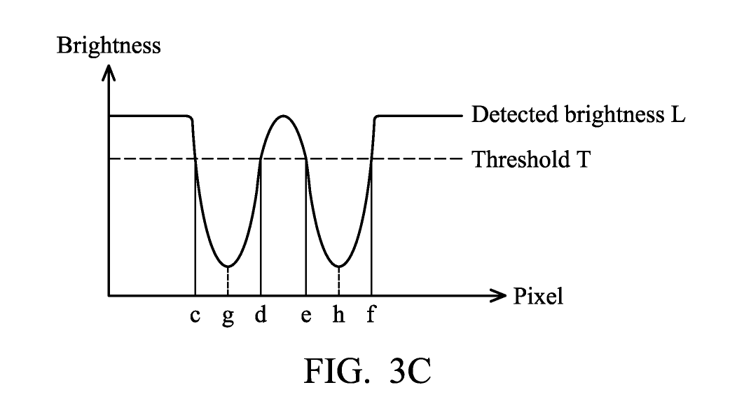

FIG. 3A illustrates a baseline segment and a brightness threshold for a pixel line segment of a standard image according to embodiments of the invention. Referring to FIG. 3A, the horizontal axis of the chart represents the positions of pixels (marked as ‘pixel’ in FIG. 3A); the vertical axis of the chart represents brightness. The brightness baseline segment B defines the brightness of a pixel of an image captured when no object is touching the touch-sensitive screen. The threshold T defines a threshold for determining whether there is an object approaching or touching the touch-sensitive screen. When the detected brightness strays from the brightness baseline segment by more than the threshold, it is determined that there is an object approaching or touching the touch-sensitive screen.

In step S203, an object image is received. As described, the object image refers to an image captured when at least one object is touching the touch-sensitive screen.

The image-sensing device periodically captures an image according to a preset period. For example, the image-sensing device can capture 16 images in a second. The “standard image taken when no object is touching the touch-sensitive screen” and the “object image taken when one object is touching the touch-sensitive screen” are used here as examples, for simplicity. According to this embodiment, images are taken continuously, whether an object touching the touch-sensitive screen or not.

The standard and object image are illustrated by the brightness of a single pixel line segment. FIG. 3B illustrates brightness for a pixel line segment in an object image according to embodiments of the invention. Referring to FIG. 3B, the horizontal axis of the chart represents the positions of pixels (marked as ‘pixel’ in FIG. 3B); the vertical axis of the chart represents brightness. The brightness L is a detected value for brightness at a point in time. When an object is touching or approaching the touch-sensitive screen 110, the detected value of the brightness corresponding to a pixel in an object image decreases. Referring to FIG. 3B, the detected value of the brightness has a major decrease and a minor decrease.

In step S205, the position of the object is calculated according to the standard image and the object image.

Referring to FIG. 3B, the detected value of brightness has a major decrease and a minor decrease. The lowest value of the minor decrease is higher than the threshold. Therefore the minor decrease is treated as noise. On the other hand, the lowest value of the major decrease is lower than the threshold. Therefore, the major decrease is interpreted as presenting an object touching the touch-sensitive screen.

The position of the object can be calculated as follows. First, the meeting points of the brightness line segment L and the threshold line segment T are located. As shown in FIG. 3B, two meeting points are located, at pixel ‘a’ and pixel ‘b’ (referring to meeting points a and b). At meeting points a and b, the brightness value equals the threshold value; between meeting points a and b, the brightness value is lower than the threshold value. A middle point of the line segment ab is calculated and is regarded as the position of the object.

The procedure for determining the position of the object is an example, and is not meant to limit the invention. For example, pixel p, which is at a position with the lowest brightness value, can be regarded as the position of the object.

In step S207, a range covered or touched by the object is calculated according to the standard image and the object image.

Again, referring to FIG. 3B, the distance between meeting points a and b is calculated. In this calculation, ‘pixel’ is used as a unit of measurement.

In step S209, the coordinates of a painting spot are calculated according to the position of the object calculated in step S205. In addition, in step S209, the size of the painting spot is calculated according to the range covered or touched by the object obtained in step S207.

In step S211, the touch-sensitive screen 110 displays the painting spot with the defined size on a position defined by the coordinates. Here, the size of the painting spot represents the diameter of the painting spot.

When an object touching and moving on the touch-sensitive screen is detected from a series of images taken at successive points in time, the touch-sensitive screen 110 displays a line segment correspondingly. The displayed line segment is defined by the painting spots corresponding to the points in time, and the width of the line segment is defined by the size of the painting spots.

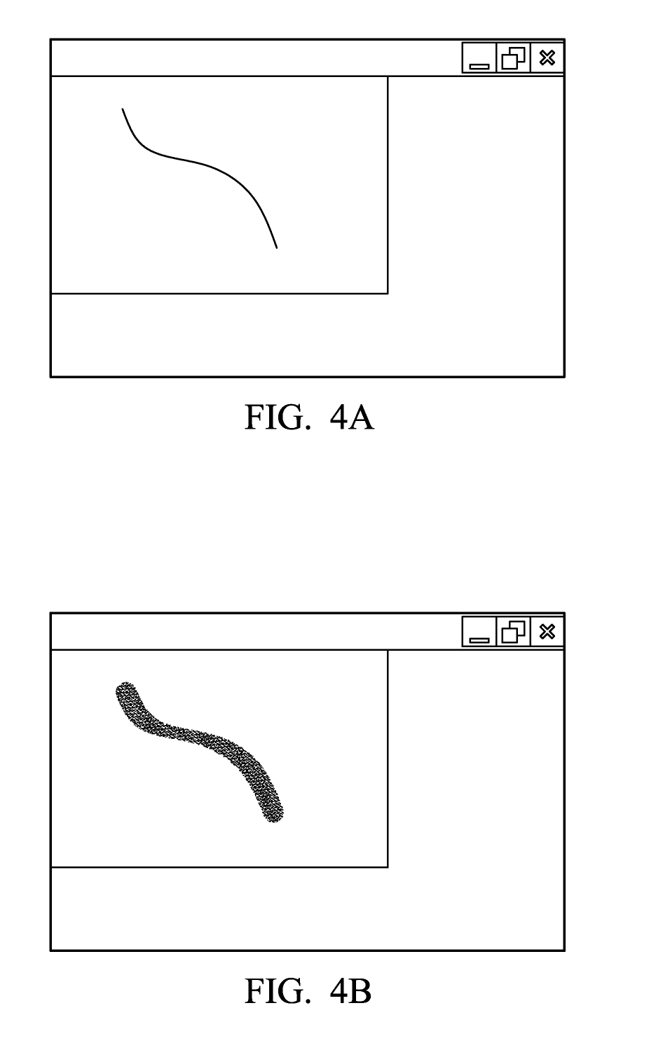

As shown in FIG. 4A, a line segment is displayed on the touch-sensitive screen 110. The line segment corresponds to the path of a moving finger as conducted by the user on the touch-sensitive screen 110. In addition, the width of the line segment corresponds to the area touched by the finger. By using the disclosed method, the user defines the width and other properties (such as color) of a painting spot or a series of painting spots (a line segment) without taking a lot of trouble to select and click items that are presented on the screen in a complex menu.

As described, the average position of the objects (fingers) defines a position for a cursor or a paint brush, and a range covered or touched by the objects defines the width of the paint brush.

In FIG. 3B, a drawing operation is performed by a single finger, and the line segment defined by this drawing operation has a relatively thin width (as shown in FIG. 4A). If the drawing operation is performed by two or more fingers, a thick line segment is generated accordingly (as shown in FIG. 4B).

For example, FIG. 3C illustrates brightness for a pixel line segment in an object image when a user is drawing on a touch-sensitive screen using two fingers. As shown in FIG. 3C, the detected brightness value has two major decreases. These two major decreases are interpreted as detecting two objects (two fingers) touching the touch-sensitive screen. First, the meeting points of the brightness line segment L and the threshold line segment T are located. In FIG. 3C, four meeting points are located at pixels ‘c’, ‘d’, ‘e’, ‘f’ (referring to meeting points c, d, e and f). At meeting points c, d, e and f, the brightness value equals the threshold value. In addition, between the meeting points c and d, brightness value is lower than threshold value; between the meeting points e and f, the brightness value is lower than the threshold value. The middle point of line segment cd is located at point g, and is regarded as the position of one object (finger). Similarly, the middle point of line segment ed is located at point h, and is regarded as the position of the other object (finger).

In situations where two or more fingers are used in the drawing operation, the longest distance between any two of the fingers is regarded as the range covered or touched by the object (finger). Using FIG. 3C as an example, the distance between pixel c and pixel f is regarded as the range covered or touched by the object, and is used for calculating the width of the line segment. As shown in FIG. 4B, a thick line segment is generated from the drawing operation performed by two fingers.

The present invention is not limited to the disclosed examples.

For example, in the embodiments disclosed above, the size of the painting spot is calculated according to the range covered or touched by the object obtained in step S207. According to another embodiment, the color of the paint brush is determined according to the distance between pixel a and pixel b. Similarly, at least the color of the line segment is determined according to the distance between pixel c and pixel f. Here, correspondence between color and distance is defined in advance, and a corresponding color can be determined accordingly.

Methods of controlling an electronic device, and related operating systems, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. An electronic device, comprising:
a touch-sensitive screen;
an image-sensing device, upon touch detecting a plurality of objects on the touch-sensitive screen, capturing image data of the objects; and
a processing device, calculating the average position of the objects according to the image data, calculating the longest distance between any two of the objects according to the image data, determining a position for a painting spot according to the calculated average position, determining a property of the painting spot according to the longest distance, and controlling the touch-sensitive screen to display the painting spot with the property on the position.

2. The electronic device of claim 1, wherein the property is the diameter of the painting spot.

3. The electronic device of claim 1, wherein the property is the color of the painting spot.

4. The electronic device of claim 1, wherein:
the image-sensing device, when the plurality of objects is moving on the touch-sensitive screen, capturing the image data of the objects at a plurality of points in time;
the processing device, calculating the average position for each of the points in time according to the image data, calculating the longest distance between any two of the objects for each of the points in time according to the image data, determining the position of the painting spot for each of the points in time according to the calculated average position for each of the points in time, determining a line segment defined by the painting spots corresponding to the points in time, and determining the color or diameter of each of the painting spots according to the longest distance.

5. The electronic device of claim 1, wherein the touch-sensitive screen displays the painting spot with the property on the position.

6. The electronic device of claim 1, wherein the touch-sensitive screen displays a cursor on the position.

7. An operation method of an electronic device, comprising:
upon touch detecting a plurality of objects on a touch-sensitive screen, capturing image data of the objects;
calculating the average position of the objects according to the image data, and calculating the longest distance between any two of the objects according to the image data; and
determining a position for a painting spot according to the calculated average position, determining a property of the painting spot according to the longest distance, and controlling the touch-sensitive screen to display the painting spot with the property on the position.

8. The method of claim 7, wherein the property is the diameter of the painting spot.

9. The method of claim 7, wherein the property is the color of the painting spot.

10. The method of claim 7, further comprising:
when the plurality of objects is moving on the touch-sensitive screen, capturing the image data of the objects at a plurality of points in time;
calculating the average position for each of the points in time according to the image data, and calculating the longest distance between any two of the objects for each of the points in time according to the image data; and
determining the position of the painting spot for each of the points in time according to the calculated average position for each of the points in time, determining a line segment defined by the painting spots corresponding to the points in time, and determining the color or diameter of each of the painting spots according to the longest distance.

11. The method of claim 7, further comprising controlling the touch-sensitive screen to display the painting spot with the property on the position

12. The method of claim 7, further comprising controlling the touch-sensitive screen to display a cursor on the position.
